(19) United States
(12) Patent Application Publication
(10) Pub. No.: US 2012/0274052 A1
(43) Pub. Date: Nov. 1, 2012

(54) Foldable shopping cart

(75) Inventor: Shou Qiang Zhu, Central (HK)

(73) Assignee: IP Power Holdings Limited

(21) Appl. No.: 13/066,952

(22) Filed: Apr. 27, 2011

(51) Int. Cl. B62B 7/06

(52) U.S. Cl. 280/651

(57) ABSTRACT

A foldable shopping cart includes a U-shaped handle having a hand gripping portion and two side portions extended from said hand gripping portion, a foldable frame movably connected to the U-shaped handle, a base frame supporting the foldable frame, and a plurality of wheels provided at the base frame for rolling on a surface. In an unfolded condition, the foldable frame constructs a basket defining a receiving cavity therein for carrying items, and in a folded condition, the foldable frame is overlappedly folded to align with the U-shaped handle so that the shopping cart is easy for storage and usage.

### BACKGROUND OF THE PRESENT INVENTION

1. Field of Invention

The present invention relates to a shopping cart, more particularly to a shopping cart adapted to fold between a folded condition and an unfolded condition so that the shopping cart is easy for storage and usage.

2. Description of Related Arts

Stores and markets are always provided with shopping carts for facilitating the shopping, transportation and purchase of goods. Customers can temporarily store their goods in the shopping carts before the payment at the check-out counter and even carry the purchased goods from the store or market to their vehicles in the parking lot. In other words, the shopping carts enable the customers easy to carry goods or items during shopping.

A typical shopping cart comprises a handle for a user to grip thereon, a fame having a mesh basket defining a container for carrying items therein, and a plurality of wheels mounted to the frame for rolling on a ground surface so that the shopping cart is convenient to be pushed/pulled forward or backward. Accordingly, the mesh basket should be large enough for carrying a large sum of items. And thus this kind of shopping cart remains generally heavy, bulky and difficult to maneuver. What's more, the store or market has to make special room for the storage of these shopping carts.

In Asia, the mesh basket of the shopping cart used in supermarket is generally made of plastic material to reduce weight. However, the plastic basket fails to provide a rigid support for storing goods or items. When larger and heavier items, such as electric appliances, are shopped, the shopping cart may fail to provide a stable support and the plastic basket may be deformed or damaged.

Recently, it is encouraged to bring your own shopping bags for shopping and a lot of supermarkets and stores start to charge for plastic or paper bags due to environmental protection and energy saving issues. However, to senior and female consumers, it is still a great burden for them to hand carry the shopping goods with the shopping bags. On our way to the store or market, we can simply employ several shopping bags to carry goods if there are not so many items to shop. But when we buy a large sum of items, a shopping cart is strongly advised.

Particularly, with the help of a shopping cart, the senior consumers may not need to lift the heavy goods by their hands. The current shopping cart can function as a tool for carrying items, but it is not convenient for storage. In other words, the conventional shopping cart is only suitable for use within the store or market. Therefore, a portable and flexible shopping cart which has a light weight and is collapsible to a compact size for hand carrying or storing in the trunk of a vehicle is highly desired by the consumers for shopping or other purposes.

### SUMMARY OF THE PRESENT INVENTION

The main object of the present invention is to provide a shopping cart adapted to fold between a folded condition and an unfolded condition so that the shopping cart is easy for carrying, storage and usage.

Another object of the present invention is to provide a foldable shopping cart which has a simple, rigid and strong structure while manufacturing in lower cost to enable it being affordable to all consumers.

Another object of the present invention is to provide a foldable shopping cart, wherein a U-shaped handle is movably connected to a foldable frame, when the shopping cart is in the unfolded condition, the foldable frame defines a basket for receiving items, and when the shopping cart is in the folded condition, the foldable frame is folded to align with the handle so that the shopping cart is convenient for storage and transportation.

Another object of the present invention is to provide a foldable shopping cart, wherein a base frame is connected to the foldable frame, wherein the base frame comprises a front support bar and a rear support bar. The front support bar is movably coupled with the handle and the foldable frame, wherein when the shopping cart is in the unfolded condition, the front bar servers as a support for the basket constructed by the foldable frame so that the shopping cart is capable of supporting a heavy load weight.

Another object of the present invention is to provide a foldable shopping cart, wherein the foldable frame comprises a front frame, a rear frame, two side frames and a base panel to construct a basket defining a receiving cavity therein, the base panel is movably connected to the front support bar so that when the foldable frame define the basket in the unfolded condition, the front support bar supports the base panel so that a large sum of items can be put on the base panel.

Another object of the present invention is to provide a foldable shopping cart, wherein a plurality of front wheels are movably and rotatably mounted to two end portions of the handle respectively, so that the front wheels are capable of changing their directions so that the shopping cart is convenient for directing to the desired orientation.

Another object of the present invention is to provide a foldable shopping cart, wherein the two side frames of the foldable frame are movably connected to the two side portions of the handle via two retention ribs respectively. Therefore, when the foldable frame is in the unfolded condition, the two side portions of the handle enhance the stability of the basket by providing supporting surface at the two lateral sides of the basket.

Another object of the present invention is to provide a foldable shopping cart, wherein a length of the front support bar is relatively shorter than the rear support bar of the base frame, so that when the shopping cart is at the folded condition, the front wheels are aligned to overlap with the rear wheels, and thus the base panel and the front frame of the foldable frame are overlapedly folded with the rear frame.

Additional advantages and features of the invention will become apparent from the description which follows, and may be realized by means of the instrumentalities and combinations particular point out in the appended claims.

According to the present invention, the foregoing and other objects and advantages are attained by a foldable shopping cart adapted to fold between a folded condition and an unfolded condition, wherein the foldable shopping cart comprises a U-shaped handle comprising a hand gripping portion and two side portions pivotally extended from said hand gripping portion, a foldable frame movably connected to the U-shaped handle, a base frame supporting the foldable frame, and a plurality of wheels provided at the base frame for rolling on a surface, wherein in the unfolded condition, the foldable frame defines a basket having a receiving cavity for carrying items therein, and in the folded condition, the foldable frame is overlappedly folded to align with the U-shaped handle.

Still further objects and advantages will become apparent from a consideration of the ensuing description and drawings.

These and other objectives, features, and advantages of the present invention will become apparent from the following detailed description, the accompanying drawings, and the appended claims.

### BRIEF DESCRIPTION OF THE DRAWINGS

FIG. 1 is a perspective view of a foldable shopping cart in an unfolded condition according to a preferred embodiment of the present invention.

FIG. 2 is an exploded view of the foldable shopping cart according to the above preferred embodiment of the present invention.

FIG. 3 is a partial enlarged view illustrating the pivotal connection between the U-shaped handle, the front support bar of the base frame, the rigid support base panel, and the front frame of the foldable frame, according to the above preferred embodiment of the present invention.

FIG. 4A is a perspective view illustrating a front wheel is movably mounted to the end portion of the U-shaped handle via two retention members according to the above preferred embodiment of the present invention.

FIG. 4B is a perspective view illustrating a rear wheel is mounted to each rear support bar of the base frame according to the above preferred embodiment of the present invention.

FIG. 5 is a perspective view illustrating the front frame of the foldable shopping cart which is overlappedly folded to the rear frame of the foldable shopping cart according to the above preferred embodiment of the present invention.

FIG. 6 is a perspective view illustrating the foldable shopping cart in the folded condition according to the above preferred embodiment of the present invention.

### DETAILED DESCRIPTION OF THE PREFERRED EMBODIMENT

In the following detailed description, reference is made to the accompanying drawings which form a part hereof, and is shown by way of illustration specific embodiments in which the invention can be reduced to practice. In this regard, directional terminology, such as “front”, “rear”, “side”, “left”, “right”, “top”, “bottom” etc., is used with reference to the orientation of the figures being described. Because components of embodiments of the present invention can be positioned in a number of different orientations, the directional terminology is used for purposes of illustration and is in no way limiting.

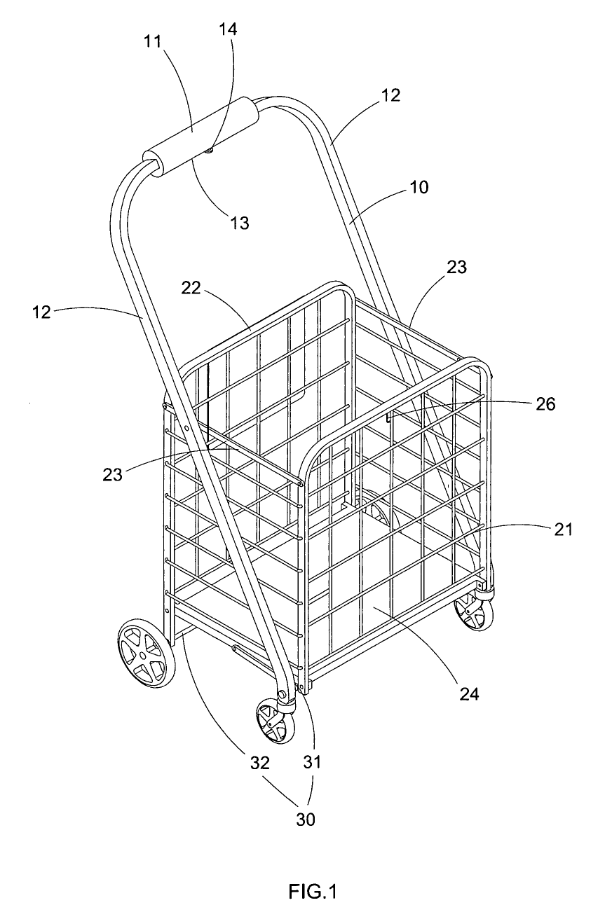

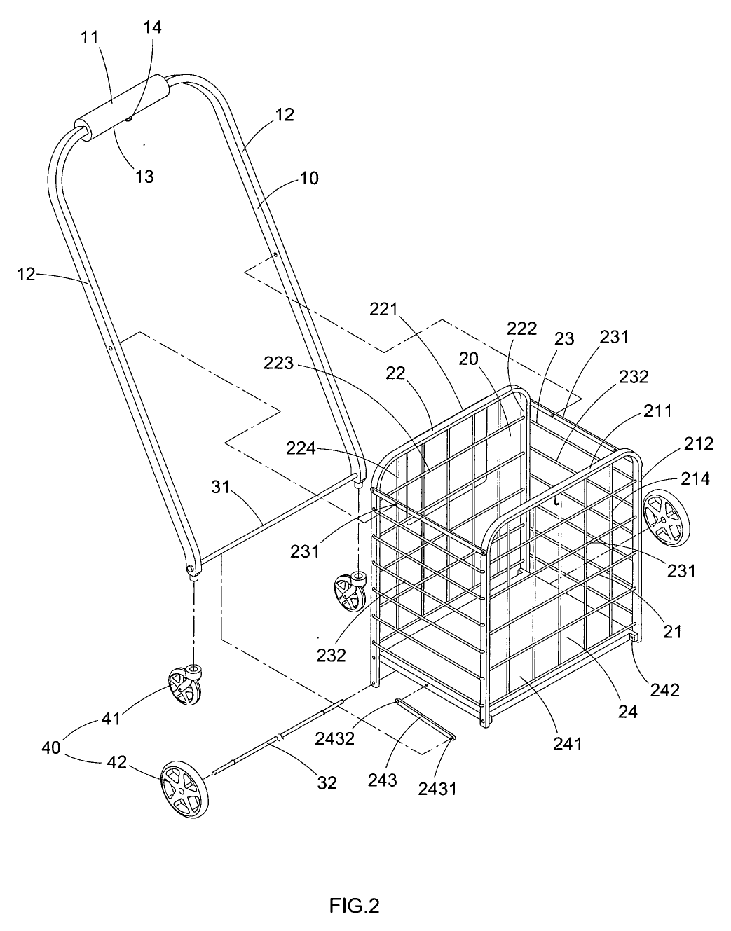

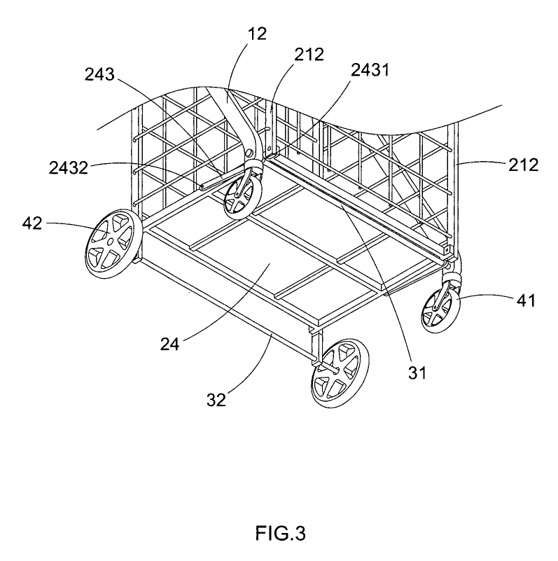

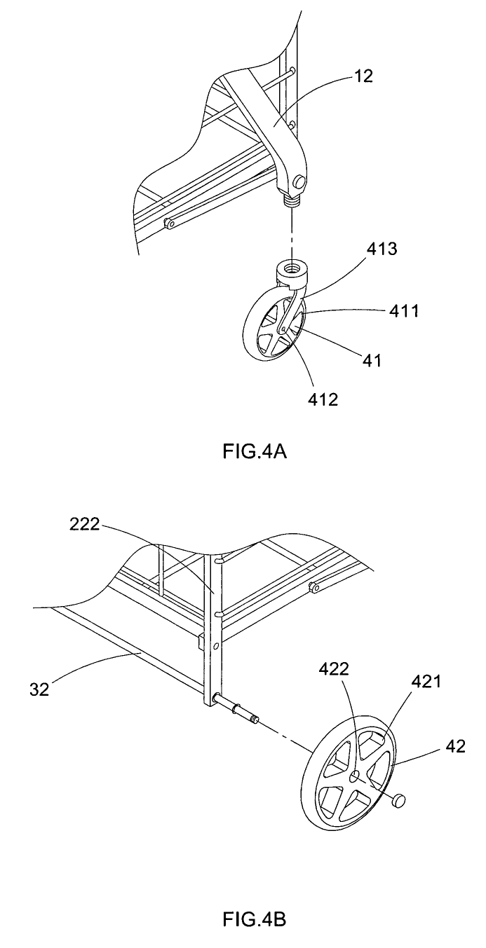

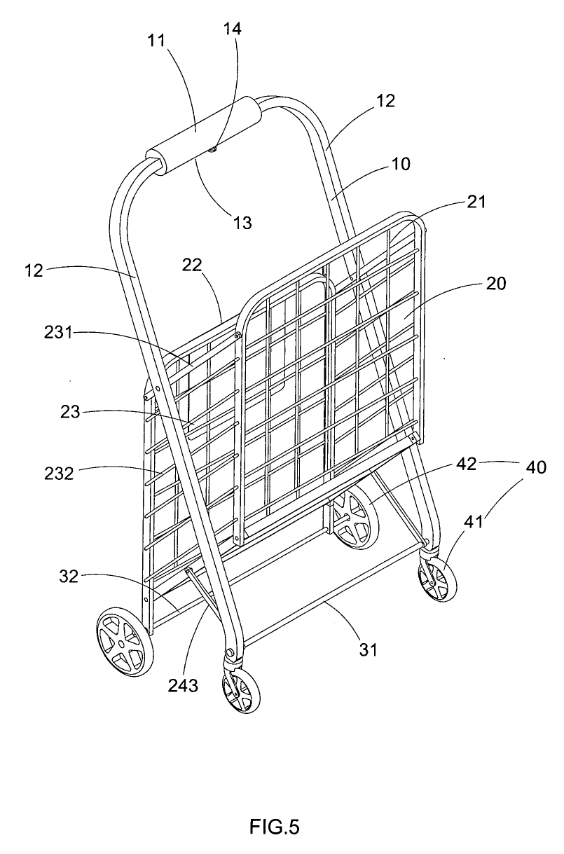

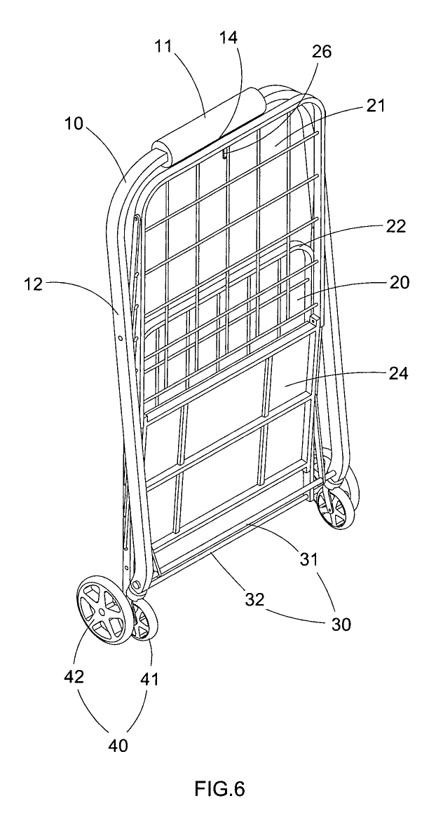

Referring to FIG. 1, FIG. 2, FIG. 3, FIG. 4A, FIG. 4B, FIG. 5, FIG. 6 of the drawings, a foldable shopping cart according to a preferred embodiment of the present invention is illustrated, wherein the foldable shopping cart comprises a handle 10, a foldable frame 20 movably connected to the handle 20, a base frame 30 supporting the foldable frame 20, and a plurality of wheels 40 provided at the base frame 30 adapted for rolling on a surface.

Referring to FIG. 2 of the drawing, the handle 10 is preferably constructed in U-shape, wherein the handle 10 comprises a hand gripping portion 11 and two side portions 12 extended from the hand gripping portion 11. Accordingly, the foldable frame 20 is mounted between the two side portions 12. The hand gripping portion 11 is adapted for user's hands to hold thereon so that the user can pull or push the shopping cart by operating the handle 10.

It is worth mentioning that the U-shaped handle 10 may be made from an integral elongated metal piece, wherein the hand gripping portion 11 is further provided with a cover element 13, which can be embodied as a fabric layer, foam layer or a plastic layer, wrapping around the hand gripping portion 11 for enhancing the frictional contact between a user's hand and the hand gripping portion 11.

The foldable frame 20 is adapted to fold between a folded condition and an unfolded condition. Accordingly, the foldable frame 20 constructs a basket defining a receiving cavity therein for carrying items in the unfolded condition, and is overlappedly folded to align with the U-shaped handle 20 in the folded condition.

The base frame 30 serves as a base for supporting the foldable frame 20 when the foldable frame 20 is in the unfolded condition. Accordingly, the base frame comprises a front support bar 31 and a rear support bar 32. Each of the front support bar 31 and the rear support bar 32 can be embodied as a metal member, wherein two ends of the side portions 12 of the handle 10 are pivotally and movably connected to two ends of the front support bar 31, and the rear support bar 32 is directly coupled with the foldable frame 20, so that when the foldable frame is in the unfolded condition, the front support bar 31 and the rear support bar 32 can support the basket constructed by the foldable frame 20 and the items received in the receiving cavity thereof.

Referring to FIG. 2 of the drawing, the foldable frame 20 has a front side, a rear side opposite to the front side, two lateral sides, i.e. a left side and a right side, and a bottom side. Accordingly, the foldable frame 20 comprise a front frame 21, a rear frame 22, two side frames 23 and a supporting panel 24 to construct the basket defining the receiving cavity for carrying items therein in the unfolded condition.

The front frame 10 and the rear frame 20 can be selectively embodied into a plastic or metal board. In this preferred embodiment, the front frame 21 comprises a front upper arm 211, two front legs 212 integrally and downwardly extended from the front upper arm 211. Correspondingly, the rear frame 22 comprises a rear upper arm 221 and two rear legs 222 integrally and downwardly extended from the rear upper arm 221. In other words, the front frame 21 and the rear frame 22 have the same structure and each comprises a front upper arm 211, 222 and two legs 212, 222 to define a U-shaped frame.

Furthermore, the front frame 21 comprises a plurality of horizontal ribs 213 and a plurality of vertical ribs 214 spacedly provided within the U-shaped frame between the front upper arm 211 and two front legs 212 to form a mesh front frame. Correspondingly, the rear frame 22 comprises a plurality of horizontal ribs 223 and a plurality of vertical ribs 224 within the U-shaped frame between the rear upper arm 221 and two rear legs 222 to form a mesh rear frame.

It is worth mentioning that the ribs of the front frame 21 and the rear frame 22 can be made of plastic, nylon material, high density polyethylene (HDPE) material, or metal. What's more, the ribs may not have to be strictly extended horizontally and vertically, in other words, the ribs can be inclinedly extended between the upper arm 211, 221 and the legs 212, 222 so that the mesh pattern can be varied.

Accordingly, the two rear legs 222 of the rear frame 22 are connected to two end portions of the rear support bar 32 respectively, so that the foldable frame 20 is connected to the base frame 30.

Each of the side frames 23 comprises a retention rib 231 having two ends movably connected to the front leg 212 of the front frame 21 and the rear leg 222 of the rear frame 22 respectively. In other words, the front frame 21 and the rear frame 22 are connected by two retention ribs 231 therebetween. Furthermore, each of the side frames 23 comprises a plurality of transverse ribs 232 movably connected to the respective front leg 212 of the front frame 21 and the respective rear leg 222 of the rear frame 22 so as to be parallelly and spacedly extended between the front frame 21 and the rear frame 22. And thus the plurality of horizontal ribs 213, 223, the plurality of vertical ribs 214, 224 and the plurality of transverse ribs 232 form a mesh pattern for the basket constructed by the foldable frame 20 in the unfolded condition. Accordingly, unlike the front frame 21 and the rear frame 22, each of the side frames 23 only comprises transverse ribs 231 without vertical edges so as to provide convenience for pivotal movement of the front frame 21 with respect to the rear frame 22.

The base panel 24 comprises a panel body 241 and four protrusion ridges, that is two front protrusion ridges 241 and two rear protrusion ridges 242, at the four corners of the panel body 241 respectively. Accordingly, the panel body is preferably constructed in square shape and made of metal or other rigid material so as to provide rigid supporting force, so that the foldable frame 20 is able to support heavy weight items. And thus the foldable frame 20 will not be prone to deform its shape.

The two rear protrusion ridges 242 are pivotally and rotatably connected to the two rear legs 222 of the rear frame 22 respectively so that the base panel 24 is adapted to pivotally rotate with respect to the two rear legs 222 of the rear frame 22. The front protrusion ridges 241 are pivotally and rotatably connected to the two front legs 212 of the rear frame 21 respectively, as shown in FIG. 3. Thus, the base panel 24 is adapted to pivotally rotate with respect to the two front legs 212 of the rear frame 21. Therefore, the front frame 21, the rear frame 22, the two side frames 23, and the base panel 24 are capable of constructing the basket having the receiving cavity for carrying items therein in the unfolded condition. And, when the foldable frame 20 is in the folded condition, the front frame 21 and the base panel 24 are folded to overlappedly align with the rear frame 22.

Accordingly, two ends of the side portion 12 of the U-shaped handle 10 are pivotally and movably connected to two ends of the front support bar 31 respectively. In addition, the side portions 12 of the U-shaped handle 10 are movably connected to two retention ribs 231 respectively, so that the U-shaped handle is movably connected to foldable frame 20. It is noteworthy that when the foldable frame 20 is in the unfolded condition, the two side portions 12 of the U-shaped handle mount the basket defined by the front frame 21, the rear frame 22, the two side frames 23, and the base panel 24 and provide supporting force to the two side frames 23 so as to enhance the stability of the basket. Furthermore, the two side portions 12 of the U-shaped handle 10 are movably connected to the two retention ribs 231 respectively at a position adjacent to the two rear legs 222 of the rear frame in such a manner that the two side portions 12 of the U-shaped handle 10 are inclinedly extended from the front support bar 31.

Referring to FIG. 3 of the drawing, the base panel 24 further comprises two pivot arms 243, wherein a first end 2431 of the pivot arm 243 is mounted to an end of the front support bar 31, a second end 2432 of the pivot arm 243 is movably provided at a side edge of the base panel 24. Therefore, when the foldable frame 20 is in the unfolded condition constructing the basket, the front support bar 31 provides supporting force to the base panel 24 so that the front support bar 31 is capable of supporting the basket with items therein. Furthermore, when the front frame 21 and the base panel 24 are folded to overlappedly align with the rear frame 22, the two pivot arms 243 guide the front support bar 31 to move towards the rear support bar 32. It thus can be seen that the front support bar 31 is connected to the foldable frame 20 via the two pivot arms 243 to provide supporting force, while the rear support bar 32 is directly mounted to the two rear legs 222 of the rear frame 22 so as to support the foldable frame 20. In other words, the front support bar 31 is not connected to the front legs 212 of the front frame 21 so that the front frame 21 is capable of folding towards the rear frame 22 in the folded condition.

Referring to FIG. 4A of the drawing, the plurality of wheels 40 comprises two front wheels 41 and two rear wheels 42, wherein each of the two front wheels 41 comprises a front wheel body 411 and a central axis 412, wherein two retention elements 413 are extended from the two ends of the central axis 412 of each front wheel 41 respectively to couple with the end of the side portion 12 of the U-shaped handle 10 and the end of the front support bar 31.

Referring to FIG. 4B of the drawing, each of the rear wheels 42 comprises a rear wheel body 421 defining a retention hole 422, wherein the two ends of the rear support bar 32 are received in the retention holes 422 of the two rear wheels 42 respectively so that the two rear wheels 42 are directly mounted to the rear support bar 32. In other words, the two rear wheels 41 rotates with respect to the rear support bar 32. It is worth mentioning that the two front wheels 41 rotate freely between the two retention elements 413 so that the two front wheels 41 are easy to change their directions. In other words, the two front wheels 41 are capable of being directed to the desired orientation by properly operating the U-shape handle 10. And thus, unlike the rear wheels, the front wheels 41 are not directly mounted to the front support bar 31 so that the user can easily change the direction of the shopping cart.

It is worth mentioning that a length of the front support bar 31 is relatively shorter than a length of the rear support bar 32. Therefore, the distance between a front wheel 41 and a front leg 212 of the front frame 21 is relatively shorter than the distance between a rear wheel 42 and a rear leg 222 of the rear frame 22. Thus, when the foldable frame is in the folded condition, the front support bar 31 moves towards the rear support bar 32 and guides the front wheels 41 to be at a position between a rear wheel 42 and a rear leg 222 of the rear frame 22. In other words, when the foldable frame 20 is in the folded condition, the front frame 21 and the base panel 24 are completely and overlappedly folded to the rear frame 22, as shown in FIG. 6.

The foldable frame 20 may further comprise a fabric pocket 25 provided at the rear upper arm 221 so that the users can put their wallet, coins or other small items in the fabric pocket 25. A hook member 26 is provided at the front upper arm 211, and correspondingly, the U-shape handle 10 comprises a holding member 14 protruded from the hand gripping portion 11, or protruded from the bottom surface of the cover element 13 on the hand gripping portion 11. Thus, when the front frame 21 is folded to overlap with the rear frame 22, the hook member 26 of the foldable frame 20 is engaged with the holding member 14 of the U-shaped handle 10 so as to retain the foldable frame 20 in the folded condition. It is worth mentioning that the length of the side edge of the base panel 24 plus the height of the front leg 212 of the front frame 21 are substantially the same as the length of the side portion 12 of the U-shaped handle 10. Therefore, when the shopping cart is in the folded condition, the front upper arm 211 of the front frame 21 is capable of align with the hand gripping portion 11 of the U-shaped handle in the same horizontal level.

It is worth mentioning that the movable connection between the components of the shopping cart can be achieved by rivets, screws, bolts and the like. In a preferred embodiment, the side portions 12 of the U-shaped handle 10 are movably connected to the retention ribs 231 by rivets, the two ends of the retention ribs 231 are riveted to the front leg 212 and the rear leg 222 respectively, the protrusion ridges 242 of the base pane 24 are also riveted to the front leg 212 or the rear leg 222, and the pivot arms 243 are also fixed to the side edges of the base panel 24 by rivets.

FIG. 5 and FIG. 6 illustrate the foldable frame 20 which moves from the unfolded condition to the folded condition. Referring to FIG. 5 of the drawing, when the foldable frame 20 is in the unfolded condition, by holding on the front upper arm 211 or the hook member 26 to lift up the front frame 21, the front frame 21 will lift up the base panel 24 and rotate about the two rear legs 222 of the rear frame 22, wherein the retention ribs 231 and the plurality of transverse ribs 232 simultaneously rotate with respect to the rear leg 222 of the rear frame 22. At the same time, because the base panel 24 is lifted up, the pivot arm 243 of the base panel leads the front support bar 31 to move towards the rear support bar 32, and thus the front wheels 41 rotate towards the rear wheels 42.

Referring to FIG. 6 of the drawing, when the shopping cart is in the folded condition, the front frame 21 and the base panel 24 are lifted up in an upright standing position to overlap with the rear frame 22. In addition, the front frame 21 can be fixed to the U-shaped handle 10 via the engagement between the hook member 26 and the holding member 14. The retention ribs 231 and transverse ribs 232 are all extended in a substantial vertical direction. The front support bar 31 is moved to a position parallel and adjacent to the rear support bar 32, and the front wheels 41 are hidden between the rear wheels 42 and the rear legs 222 of the rear frame 22. Thus, the foldable frame 20 is overlappedly folded to align with the U-shaped handle 10 so that the shopping car is easy for storage and transportation.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A foldable shopping car adapted to fold between an unfolded condition and a folded condition, comprising:
a U-shaped handle comprising a hand gripping portion and two side portions extended from said hand gripping portion;
a foldable frame movably connected to said U-shaped handle;
a base frame supporting said foldable frame; and
a plurality of wheels provided at said base frame for rolling on a surface, wherein in said unfolded condition, said foldable frame constructs a basket defining a receiving cavity therein for carrying items, and in said folded condition, said foldable frame is overlappedly folded to align with said U-shaped handle.

2. The foldable shopping cart, as recited in claim 1, wherein said base frame comprises a front support bar and a rear support bar, wherein two ends of said side portions of said U-shaped handle are pivotally and movably connected to two ends of said front support bar respectively.

3. The foldable shopping cart, as recited in claim 1, wherein said foldable frame comprises a front frame, a rear frame, two side frames, and a base panel to construct said basket defining said receiving cavity therein for carrying items in said unfolded condition.

4. The foldable shopping cart, as recited in claim 2, wherein said foldable frame comprises a front frame, a rear frame, two side frames and a base panel to construct said basket defining said receiving cavity therein for carrying items in said unfolded condition.

5. The foldable shopping cart, as recited in claim 3, wherein said front frame comprises a front U-shaped frame having a front upper arm, two front legs integrally and downwardly extended from said front upper arm, wherein said rear frame comprises a rear U-shaped frame having a rear upper arm and two rear legs integrally and downwardly extended from said rear upper arm.

6. The foldable shopping cart, as recited in claim 4, wherein said front frame comprises a front U-shaped frame having a front upper arm, two front legs integrally and downwardly extended from said front upper arm, wherein said rear frame comprises a rear U-shaped frame having a rear upper arm and two rear legs integrally and downwardly extended from said rear upper arm.

7. The foldable shopping cart, as recited in claim 5, wherein said base panel comprises a panel body, two front protrusion ridges and two rear protrusion ridges provided at said four corners of said panel body, wherein said two rear protrusion ridges are pivotally and rotatably connected to said two rear legs of said rear frame respectively, wherein said two front protrusion ridges are pivotally and rotatably connected to said two front legs of said rear frame respectively.

8. The foldable shopping cart, as recited in claim 6, wherein said base panel comprises a panel body, two front protrusion ridges and two rear protrusion ridges provided at said four corners of said panel body, wherein said two rear protrusion ridges are pivotally and rotatably connected to said two rear legs of said rear frame respectively, wherein said two front protrusion ridges are pivotally and rotatably connected to said two front legs of said rear frame respectively.

9. The foldable shopping cart, as recited in claim 5, wherein said front frame and said rear frame further comprise a plurality of horizontal ribs and a plurality of vertical ribs spacedly provided within said front U-shaped frame and said rear U-shaped frame respectively, wherein each of said side frames comprises a plurality of transverse ribs movably connected to said front leg of said front frame and said rear leg of said rear frame to be parallelly and spacedly extended between said front frame and said rear frame, so that a mesh pattern is formed for said basket constructed by said foldable frame in said unfolded condition.

10. The foldable shopping cart, as recited in claim 6, wherein said front frame and said rear frame further comprise a plurality of horizontal ribs and a plurality of vertical ribs spacedly provided within said front U-shaped frame and said rear U-shaped frame respectively, wherein each of said side frames comprises a plurality of transverse ribs movably connected to said front leg of said front frame and said rear leg of said rear frame to be parallelly and spacedly extended between said front frame and said rear frame, so that a mesh pattern is formed for said basket constructed by said foldable frame in said unfolded condition.

11. The foldable shopping cart, as recited in claim 8, wherein said front frame and said rear frame further comprise a plurality of horizontal ribs and a plurality of vertical ribs spacedly provided within said front U-shaped frame and said rear U-shaped frame respectively, wherein each of said side frames comprises a plurality of transverse ribs movably connected to said front leg of said front frame and said rear leg of said rear frame to be parallelly and spacedly extended between said front frame and said rear frame, so that a mesh pattern is formed for said basket constructed by said foldable frame in said unfolded condition.

12. The foldable shopping cart, as recited in claim 5, wherein each of said side frames comprises a retention rib having two ends movably connected to said front leg of said front frame and said rear leg of said rear frame respectively, wherein said side portions of said U-shaped handle are movably connected to said retention ribs so that said U-shaped handle is movably connected to said foldable frame in such a manner that said side portions of said U-shaped handle mount said basket constructed by said foldable frame in said unfolded condition.

13. The foldable shopping cart, as recited in claim 6, wherein each of said side frames comprises a retention rib having two ends movably connected to said front leg of said front frame and said rear leg of said rear frame respectively, wherein said side portions of said U-shaped handle are movably connected to said retention ribs so that said U-shaped handle is movably connected to said foldable frame in such a manner that said side portions of said U-shaped handle mount said basket constructed by said foldable frame in said unfolded condition.

14. The foldable shopping cart, as recited in claim 8, wherein each of said side frames comprises a retention rib having two ends movably connected to said front leg of said front frame and said rear leg of said rear frame respectively, wherein said side portions of said U-shaped handle are movably connected to said retention ribs so that said U-shaped handle is movably connected to said foldable frame in such a manner that said side portions of said U-shaped handle mount said basket constructed by said foldable frame in said unfolded condition.

15. The foldable shopping cart, as recited in claim 11, wherein each of said side frames comprises a retention rib having two ends movably connected to said front leg of said front frame and said rear leg of said rear frame respectively, wherein said side portions of said U-shaped handle are movably connected to said retention ribs so that said U-shaped handle is movably connected to said foldable frame in such a manner that said side portions of said U-shaped handle mount said basket constructed by said foldable frame in said unfolded condition.

16. The foldable shopping cart, as recited in claim 14, wherein said two side portions of said U-shaped handle are movably connected to said two retention ribs respectively at a position adjacent to said two rear legs of said rear frame in such a manner that said two side portions of said U-shaped handle are inclinedly extended from said front support bar.

17. The foldable shopping cart, as recited in claim 15, wherein said two side portions of said U-shaped handle are movably connected to said two retention ribs respectively at a position adjacent to said two rear legs of said rear frame in such a manner that said two side portions of said U-shaped handle are inclinedly extended from said front support bar.

18. The foldable shopping cart, as recited in claim 6, wherein said base panel further comprises two pivot arms, wherein a first end of said pivot arm is mounted to an end of said front support bar and a second end of said pivot arm is movably provided at a side edge of said base panel, wherein when said front frame and said base panel are folded to overlappedly align with said rear frame, and said two pivot arms guide said front support bar to move towards said rear support bar.

19. The foldable shopping cart, as recited in claim 11, wherein said base panel further comprises two pivot arms, wherein a first end of said pivot arm is mounted to an end of said front support bar and a second end of said pivot arm is movably provided at a side edge of said base panel, wherein said front support bar is capable of supporting said panel body, and when said front frame and said base panel are folded to overlappedly align with said rear frame, said two pivot arms guide said front support bar to move towards said rear support bar.

20. The foldable shopping cart, as recited in claim 15, wherein said base panel further comprises two pivot arms, wherein a first end of said pivot arm is mounted to an end of said front support bar and a second end of said pivot arm is movably provided at a side edge of said base panel, wherein said front support bar is capable of supporting said panel body, and when said front frame and said base panel are folded to overlappedly align with said rear frame, said two pivot arms guide said front support bar to move towards said rear support bar.

21. The foldable shopping cart, as recited in claim 17, wherein said base panel further comprises two pivot arms, wherein a first end of said pivot arm is mounted to an end of said front support bar and a second end of said pivot arm is movably provided at a side edge of said base panel, wherein said front support bar is capable of supporting said panel body, and when said front frame and said base panel are folded to overlappedly align with said rear frame, said two pivot arms guide said front support bar to move towards said rear support bar.

22. The foldable shopping cart, as recited in claim 5, wherein said two rear legs of said rear frame are connected to two end portions of said rear support bar respectively so as to support said foldable frame.

23. The foldable shopping cart, as recited in claim 6, wherein said two rear legs of said rear frame are connected to two end portions of said rear support bar respectively so as to support said foldable frame.

24. The foldable shopping cart, as recited in claim 21, wherein said two rear legs of said rear frame are connected to two end portions of said rear support bar respectively so as to support said foldable frame.

25. The foldable shopping cart, as recited in claim 6, wherein said plurality of wheels comprises two front wheels and two rear wheels, wherein each of said two front wheels comprises a front wheel body and a central axis, wherein two retention elements are extended from said two ends of said central axis of each front wheel respectively to couple with said end of said side portion of said U-shaped handle and said end of said front support bar, wherein each of said rear wheels comprises a rear wheel body defining a retention hole, wherein said two ends of said rear support bar are received in said retention holes of said two rear wheels respectively so that said two rear wheels are directly mounted to said rear support bar.

26. The foldable shopping cart, as recited in claim 21, wherein said plurality of wheels comprises two front wheels and two rear wheels, wherein each of said two front wheels comprises a front wheel body and a central axis, wherein two retention elements are extended from said two ends of said central axis of each front wheel respectively to couple with said end of said side portion of said U-shaped handle and said end of said front support bar, wherein each of said rear wheels comprises a rear wheel body defining a retention hole, wherein said two ends of said rear support bar are received in said retention holes of said two rear wheels respectively so that said two rear wheels are directly mounted to said rear support bar.

27. The foldable shopping cart, as recited in claim 24, wherein said plurality of wheels comprises two front wheels and two rear wheels, wherein each of said two front wheels comprises a front wheel body and a central axis, wherein two retention elements are extended from said two ends of said central axis of each front wheel respectively to couple with said end of said side portion of said U-shaped handle and said end of said front support bar, wherein each of said rear wheels comprises a rear wheel body defining a retention hole, wherein said two ends of said rear support bar are received in said retention holes of said two rear wheels respectively so that said two rear wheels are directly mounted to said rear support bar.

28. The foldable shopping cart, as recited in claim 6, wherein said foldable frame further comprises a fabric pocket provided at said rear upper arm of said rear frame.

29. The foldable shopping cart, as recited in claim 27, wherein said foldable frame further comprises a fabric pocket provided at said rear upper arm of said rear frame.

30. The foldable shopping cart, as recited in claim 6, further comprising a hook member provided at said front upper arm of said front frame, wherein said U-shape handle comprises a holding member protruded from said hand gripping portion in such a manner that said hook member of said foldable frame engages with said holding member of said U-shaped handle so as to retain said foldable frame in said folded condition.

31. The foldable shopping cart, as recited in claim 29, further comprising a hook member provided at said front upper arm of said front frame, wherein said U-shape handle comprises a holding member protruded from said hand gripping portion in such a manner that said hook member of said foldable frame engages with said holding member of said U-shaped handle so as to retain said foldable frame in said folded condition.
